(19) United States
(12) Patent Application Publication
(10) Pub. No.: US 2026/0150861 A1
(43) Pub. Date: Jun. 4, 2026

(54) A GELATIN COMPOSITION AND PROCESS FOR MAKING SUCH

(71) Applicant: Tessenderlo Group NV, Brussels (BE)

(72) Inventors: Carlos MANDOLESI, Brussels (BE); Faye MAERTENS, Brussels (BE)

(21) Appl. No.: 19/123,800

(22) PCT Filed: Oct. 26, 2023
(86) PCT No.: PCT/EP2023/079975

§ 371 Date: Apr. 24, 2025

(30) Foreign Application Priority Data
Oct. 27, 2022 (EP) 22204253.3

(51) Int. Cl. A23J 3/34; A23J 3/06; A23L 29/281; A23L 29/30

(52) U.S. Cl. CPC A23J 3/342; A23J 3/06; A23L 29/284; A23L 29/30

(57) ABSTRACT

The present invention relates to a gelatin composition which has advantageous properties for transport, packaging, manipulation, processing, and so on. The present invention also relates to a process for producing such gelatin composition.

### TECHNICAL FIELD

The present invention relates to a gelatin composition which has advantageous properties for transport, packaging, manipulation, processing, and so on. The present invention also relates to a process for producing such gelatin composition.

### BACKGROUND

Compositions, usually compositions in the form of particulate solids such as powders, comprising different components having different particle sizes, are typically characterized by a segregation of the components over time, or during transport and so on. Said segregation is mainly due to the difference in particle size and density of said components. This segregation can be a disadvantage in the use of the compositions. To restore the homogeneity of the composition, a blending step is required before use.

Prior art solutions include the production of compositions by spray drying, however this is quite expensive, is limited to certain ingredients and the method is limited in terms of particle size that can be produced, possibly an agglomeration step then needs to be performed after spray drying to further increase the particle size.

The present invention intends to provide a gelatin composition that is improved in view of prior art gelatin compositions in that it is more resistant to handling steps, such as packaging, transport, storage, manipulation and the like. The composition of the present invention has improved homogeneity even after transport, manipulation, storage and so on, compared to prior art compositions as particle size segregation is reduced. Further, the composition of the present invention allows to reduce and even avoid foam formation in a capsule manufacture process. Additionally, the present invention allows to reduce the formation of lumps when the composition is used in a wet processing.

### SUMMARY OF THE INVENTION

The present invention relates to a gelatin composition comprising gelatin and one or more of a protein hydrolysate, a carbohydrate, an additive and the like, characterized in that the composition has a substantially unimodal particle size distribution.

In a further aspect of the invention there is provided a method for the production of a gelatin composition comprising the steps of:
(i) Providing an aqueous composition comprising gelatin and one or more of a protein hydrolysate, a carbohydrate, an additive and the like, and
(ii) Drying said aqueous composition; and
(iii) Optionally grinding or agglomerating, preferably grinding.
   wherein the gelatin composition has a substantially unimodal particle size.

In a further aspect, the present invention relates to the use of the composition of the present invention in the production of capsules, preferably soft capsules.

### DETAILED DESCRIPTION OF THE INVENTION

The present invention relates to a gelatin composition comprising gelatin and one or more of a protein hydrolysate, a carbohydrate, an additive and the like, characterized in that the composition has a substantially unimodal particle size distribution.

Preferably the gelatin composition of the present invention comprises, by weight of the gelatin composition, 1 wt %, 5 wt %, 10 wt %, 15 wt %, 20 wt %, 25 wt %, 30 wt %, 35 wt %, 40 wt %, 45 wt %, 50 wt %, 55 wt %, 60 wt %, 65 wt %, 70 wt %, 75 wt %, 80 wt %, 85 wt %, 90 wt %, 95 wt % or more of gelatin.

Preferably the gelatin composition of the present invention comprises, by weight of the gelatin composition, 99 wt %, 95 wt %, 90 wt %, 85 wt %, 80 wt %, 75 wt %, 70 wt %, 65 wt %, 60 wt %, 55 wt %, 50 wt %, 45 wt %, 40 wt %, 35 wt %, 30 wt %, 25 wt %, 20 wt %, 15 wt %, 10 wt %, 5 wt % or less of gelatin.

In a preferred embodiment, the gelatin composition of the present invention comprises, by weight of the gelatin composition, from 1 to 99 wt %, from 5 to 95 wt %, from 10 wt % to 90 wt %, from 50 wt % to 80 wt %, from 51 wt % to 80 wt %, from 52 wt % to 80 wt, from 53 wt % to 80 wt %, from 54 wt % to 80 wt %, from 55 wt % to 80 wt %, from 56 wt % to 80 wt %, from 57 wt % to 80 wt %, from 58 wt % to 80 wt %, from 59 wt % to 80 wt %, from 60 wt % to 80 wt %, from 61 wt % to 80 wt %, from 62 wt % to 80 wt %, from 63 wt % to 80 wt %, from 64 wt % to 80 wt %, from 65 wt % to 80 wt % of gelatin.

Collagen is the main component of connective tissues in animals and humans. Collagen consists of chains of amino acids wound together to form triple-helices which in turn form elongated fibrils. It is mostly found in fibrous tissues such as tendons, ligaments, and skin. It is also found in bones, teeth, corneas, cartilage intervertebral discs and blood vessels. Collagen for industrial processing is mostly derived from animal skins and/or bones. Collagen may be processed to produce gelatin, which is obtained by irreversible, partial hydrolysis of collagen. According to the Food Chemical Codes, gelatin is defined as the product obtained from the acid, alkaline, or enzymatic hydrolysis of collagen, the chief protein component of the skin, bones, and connective tissues of animals.

A typical gelatin production process comprises several process steps to produce gelatin from raw materials:
A pre-treatment step: before processing, the raw materials are cleaned to remove foreign materials such as dirt, metal pieces, etc.
Acid, alkaline, or enzymatic treatment of the raw materials results in the hydrolysis of collagen.
An extraction step: the raw materials are treated with warm water, during this step gelatin is extracted from the raw material matrix and solubilized in the water medium.
After the extraction step, gelatin is recovered by further steps such as purification, sterilisation, concentration and drying.

In a collagen hydrolysate production process, the gelatin after the extraction step is further hydrolysed to obtain collagen hydrolysate which is then recovered by further steps such as purification, sterilisation, concentration and drying.

Gelatin can thus be obtained from a typical industrial process, from collagen containing material such as animal skin, preferably beef hide and/or pork skin and/or fish skin, more preferably from beef hide and/or pork skin; or such as animal bones, preferably from pig bones and/or beef bones and/or fish scales/bones and/or poultry bones, more preferably from pig bones and/or fish scales/bones.

Gelatin is further characterized by its viscosity. Said viscosity may be from 1.5 mPa.s to 7 mPa.s. Preferably, said viscosity is from 2.5 mPa.s to 5.5 mPa.s, more preferably from 4.0 mPa.s to 5.5 mPa.s, even more preferably from 4.5 mPa.s to 5.5 mPa.s. Viscosity is a well-known gelatin parameter in the art and is measured according to the method detailed below.

Gelatin is further characterized by its Bloom value. The Bloom value may range from 45 g Bloom to 325 g Bloom, preferably from 90 g Bloom to 300 g Bloom, more preferably from 100 g Bloom to 300 g Bloom, even more preferably of from 150 g Bloom to 300 g Bloom, yet even more preferably 200 g Bloom to 300 g Bloom. Bloom is a well-known gelatin parameter in the art and is measured according to the method detailed below.

Preferably the gelatin has an average molecular weight of from 20 kDa to 220 kDa, preferably from 30 kDa to 150 kDa, more preferably from 40 kDa to 120 kDa, even more preferably from 40 kDa to 110 kDa, yet even more preferably from 50 kDa to 100 kDa, yet even more preferably from 60 kDa to 90 kDa (average molecular weight (Mw) measured by gel permeation chromatography (Size exclusion chromatography using linear polymers such as polystyrene sulfonates or collagen chain fragments of different molecular weights as calibration vehicles). Average molecular weight is herein weight average molecular weight.

Further, the gelatin composition of the present invention comprises, by weight of the gelatin composition, 1 wt %, 5 wt %, 10 wt %, 15 wt %, 20 wt %, 25 wt %, 30 wt %, 35 wt %, 40 wt %, 45 wt %, 50 wt %, 55 wt %, 60 wt %, 65 wt %, 70 wt %, 75 wt %, 80 wt %, 85 wt %, 90 wt %, 95 wt % or more of one or more of a protein hydrolysate, a carbohydrate, an additive and the like.

Preferably the gelatin composition of the present invention comprises, by weight of the gelatin composition, 99 wt %, 95 wt %, 90 wt %, 85 wt %, 80 wt %, 75 wt %, 70 wt %, 65 wt %, 60 wt %, 55 wt %, 50 wt %, 45 wt %, 40 wt %, 35 wt %, 30 wt %, 25 wt %, 20 wt %, 15 wt %, 10 wt %, 5 wt % or less of one or more of a protein hydrolysate, a carbohydrate, an additive and the like.

In a preferred embodiment, the gelatin composition of the present invention comprises, by weight of the gelatin composition, from 99 to 1 wt %, from 95 to 5 wt %, from 90 wt % to 10 wt %, from 50 wt % to 20 wt %, from 49 wt % to 80 wt %, from 48 wt % to 80 wt, from 47 wt % to 80 wt %, from 46 wt % to 80 wt %, from 45 wt % to 80 wt %, from 44 wt % to 80 wt %, from 43 wt % to 80 wt %, from 42 wt % to 80 wt %, from 41 wt % to 80 wt %, from 40 wt % to 80 wt %, from 39 wt % to 80 wt %, from 38 wt % to 80 wt %, from 37 wt % to 80 wt %, from 36 wt % to 80 wt %, from 35 wt % to 80 wt % of one or more of a protein hydrolysate, a carbohydrate, an additive and the like.

In a preferred embodiment further, the gelatin composition of the present invention comprises, by weight of the gelatin composition, from 20 wt % to 49 wt %, from 20 wt % to 48 wt %, from 20 wt % to 47 wt %, from 20 wt % to 46 wt %, from 20 wt % to 45 wt %, from 20 wt % to 44 wt %, from 20 wt % to 43 wt %, from 20 wt % to 42 wt %, from 20 wt % to 41 wt %, from 20 wt % to 40 wt %, from 20 wt % to 39 wt %, from 20 wt % to 38 wt %, from 20 wt % to 37 wt %, from 20 wt % to 36 wt %, from 20 wt % to 35 wt % of one or more of a protein hydrolysate, a carbohydrate, an additive and the like.

The protein hydrolysate can be any type of suitable protein hydrolysate, such as collagen hydrolysate, soy protein hydrolysate, pea protein hydrolysate, wheat protein hydrolysate, whey hydrolysate. Preferably, the protein hydrolysate is collagen hydrolysate.

The carbohydrate can be any type of suitable carbohydrate such as starch, maltodextrin, polyol, hydrocolloid and the like.

The additive may be any type of suitable additive such as a vitamin, a mineral, a plasticizer, a colouring agent, stabilizer, flavouring, and the like.

Preferably the composition of the present invention has a moisture content of from 5 to 15 wt %, preferably of 8 to 12 wt %, more preferably from 5 to 10 wt %.

In a preferred embodiment, the composition comprises gelatin and collagen hydrolysate.

Gelatin is typically characterized by a gel strength (Bloom) and in warm solution by a certain viscosity. Gelatin can be further hydrolyzed to shorter protein chains to produce collagen hydrolysate or collagen peptides, losing its ability to form a gel, and becoming even soluble in water at ambient temperatures. Hydrolysis can be done by an enzymatic treatment with endoproteases or a combination of endo-and exoproteases for example. Chemical hydrolysis may also be done.

Preferably the collagen hydrolysate has an average molecular weight of from 300 to 5000 Da, preferably from 500 to 3000 Da, further preferably from 1000 to 3000 Da (average molecular weight (Mw) measured by gel permeation chromatography (Size exclusion chromatography using linear polymers such as polystyrene sulfonates or collagen chain fragments of different molecular weights as calibration vehicles). Average molecular weight is herein weight average molecular weight.

In a preferred embodiment, the gelatin composition of the present invention comprises from 60 wt % to 80 wt % (by weight of the gelatin composition) of gelatin and from 20 wt % to 40 wt % (by weight of the gelatin composition) of collagen hydrolysate.

In another preferred embodiment, the gelatin composition of the present invention comprises from 65 wt % to 80 wt % (by weight of the gelatin composition) of gelatin and from 20 wt % to 35 wt % (by weight of the gelatin composition) of collagen hydrolysate.

The composition of the present invention preferably has a transmittance at 450 nm (T % 450 nm) of at least 50% and/or a transmittance at 620 nm (T % 620) of at least 60%. More preferably, the transmittance at 450 nm is 60% or higher, even more preferably 65% or higher. More preferably, the transmittance at 620 nm is 70% or higher, even more preferably 75% or higher. A high transmittance indicates a low opacity of the final product, which is preferred by consumers.

Preferably the composition is a free-flowing composition, in the form of particulate solid. As used herein, the expression “particulate solid” is not particularly limited to the nature of the particulate solid and in particular includes granules, prills, pellets, pastilles, powders, strips, flakes. Preferably the composition is a powder.

The composition of the present invention is characterized in that it has a substantially unimodal particle size distribution. A substantially unimodal particle size distribution as used herein means that the largest peak within the particle size distribution has an area at least 9 times as large as the next largest peak.

Such a substantially unimodal particle size distribution is advantageous in that the composition remains homogeneous during storage, transport, or manipulation of big bags. Such particle size distribution can be obtained for example when the collagen hydrolysate and the gelatin of the composition are co-dried, i.e., they are mixed together before the start of a drying step. After drying, the composition is treated such as to obtain a particle size as defined above. Said treatment can be a step to increase particle size (such as an agglomeration step for example) or a step to reduce particle size (such as a grinding step for example). Such a particle size distribution is also advantageous for use in a soft capsule manufacturing process. Indeed, such a particle size distribution is quite uniform and comprises a low amount of fine material. The presence of such fine material is typically not desired by capsule manufacturers as it results in the production of foam, which eventually can cause capsule shells with air bubbles, improper sealing, or risk of leaking, if the foam formation is not properly controlled during the capsule production process or if foam is not properly removed during the capsule production process.

Particle size distribution may be determined using mesh sizes. Such particle size may be measured at 8 mesh (2.36 mm opening), 10 mesh (2 mm opening), 14 mesh (1.40 mm opening), 20 mesh (0.85 mm opening), 40 mesh (0.425 mm opening), 60 mesh (0.250 mm opening), 100 mesh (0.150 mm opening), 200 mesh (0.075 mm opening), 400 mesh (0.038 mm opening). Preferably, at least 50 wt %, preferably at least 55 wt %, more preferably at least 60 wt %, even more preferably at least 65 wt %, yet even more preferably at least 70 wt %, yet even more preferably at least 75 wt %, yet even more preferably at least 80 wt %, yet even more preferably at least 85 wt %, yet even more preferably at least 90 wt % of the composition has the same particle size measured using the previous mesh sizes.

In one preferred embodiment, the composition of the present invention is provided in the form of a particulate solid having a particle size distribution wherein the main peak is measured at 14 mesh (1.40 mm opening). Preferably thus, at least 50 wt %, preferably at least 55 wt %, more preferably at least 60 wt %, even more preferably at least 65 wt %, yet even more preferably at least 70 wt %, yet even more preferably at least 75 wt % of the composition has a particle size measured at 14 mesh, i.e., the composition has a particle size of higher than 1.40 mm up to 2 mm. Further preferably at most 5 wt %, more preferably at most 3 wt %, more preferably at most 2 wt % of the composition has a particle size of 0.85 mm or less. Further preferably at most 1 wt %, more preferably at most 0.5 wt % of the composition has a particle size of 0.425 mm or less.

In another preferred embodiment, the composition of the present invention is provided in the form of a particulate solid having a particle size distribution wherein the main peak is measured at 400 mesh (0.038 mm opening). Preferably thus, at least 50 wt %, preferably at least 55 wt %, more preferably at least 60 wt %, even more preferably at least 65 wt %, yet even more preferably at least 70 wt %, yet even more preferably at least 75 wt % of the composition has a particle size measured at 400 mesh, i.e., has a particle size of higher than 0.038 mm up to 0.075 mm. Further preferably at most 5 wt %, more preferably at most 3 wt %, more preferably at most 2 wt % of the composition has a particle size measured at 100 mesh, i.e., has a particle size higher than 0.150 mm. Further preferably at most 1 wt %, more preferably at most 0.5 wt % of the composition has a particle size measured at 60 mesh, i.e., has a particle size higher than 0.250 mm.

The composition of the present invention is produced by co-drying a desired amount of gelatin with a desired amount of other components, preferably collagen hydrolysate. Co-drying is advantageous in that particle segregation or separation is reduced and thus the composition remains homogeneous during storage, transport, or manipulation of packaging such as big bags. On the contrary, when the components are for example dry blended, they will typically have a bimodal particle size distribution, particle segregation can occur during storage, manipulation, or transport, due to a difference in density and a difference in particle size distribution between the components. The separation can lead to non-uniform compositions, as the finer material, for example collagen hydrolysate powder, has a smaller particle size and will be present in higher amounts at the top of the packaging, whereas the coarser material, typically the gelatin powder, will be present at the bottom of the packaging. It is then necessary to include a blending step before using the composition in a manufacturing process, such as a capsule manufacturing process for example. This additional blending step can be a disadvantage for the (capsule) manufacturer as this requires additional blending apparatus, storage tanks and ingredient manipulation, with the problem of dust formation for example.

Hence, in a further aspect of the invention there is provided a method for the production of a gelatin composition comprising the steps of:
(i) Providing an aqueous composition comprising gelatin and one or more of a protein hydrolysate, a carbohydrate, an additive and the like, and
(ii) Drying said aqueous composition; and
(iii) Optionally grinding or agglomerating, preferably grinding,
   wherein preferably the gelatin composition has a substantially unimodal particle size as defined herein.

In the method of the present invention, the gelatin composition is preferably the gelatin composition described herein. The preferred embodiments described herein for the gelatin composition (e.g., concentration and properties of the gelatin, concentration and properties of the collagen hydrolysate, particle size distribution, etc.) apply mutatis mutandis to the method for the production of a gelatin composition described herein.

Such a method is referred to herein as co-drying. Drying may be done by any suitable technique known in the art, such as spray drying, rotary drum drying, drying in a flow of hot air, belt drying, tunnel drying and the like. Drying is preferably performed using tunnel drying. Drying is performed until the composition has a moisture content of from 5 wt % to 15 wt %, preferably of 8 to 12 wt %, more preferably 5 wt % to 10 wt %.

The present invention preferably further relates to a gelatin composition obtainable by the co-drying method described herein. The gelatin composition obtainable by the co-drying method described herein is preferably the gelation composition described herein earlier, in particular in accordance with the preferred embodiments of the invention.

The aqueous composition of step (i) can be obtained in different ways.

The gelatin and the one or more of a protein hydrolysate, a carbohydrate, an additive and the like can be added in water at a suitable temperature to provide the aqueous composition which is then dried and optionally ground. Alternatively, the aqueous composition of step (i) is obtained during the manufacturing process of gelatin, wherein the one or more of a protein hydrolysate, a carbohydrate, an additive and the like, in powder or liquid form or any other suitable form, is added to gelatin which is solubilized in the extraction medium after the gelatin extraction step. The mixture is then dried in a suitable manner and optionally ground.

In the preferred embodiment wherein the protein hydrolysate is preferably collagen hydrolysate, the aqueous composition of step (i) can be obtained in different ways. Collagen hydrolysate and gelatin in powder form can be dissolved in water to provide the aqueous composition which is then dried and optionally ground.

Collagen hydrolysate can be produced in situ during the gelatin manufacturing process, after the gelatin extraction step. Gelatin is then dissolved in the extraction medium (typically water) and part of it can be further hydrolysed whereby an aqueous mixture of gelatin and collagen hydrolysate is produced. The mixture can then be dried in a suitable manner.

Preferably, the aqueous composition of step (i) is obtained during the manufacturing process of gelatin, wherein collagen hydrolysate, in powder or liquid form, is added to gelatin which is solubilized in the extraction medium after the gelatin extraction step. The mixture is then dried in a suitable manner and optionally ground.

Preferably in the process of the present invention, a grinding step is performed in order to obtain the desired particle size. Grinding can be performed with any suitable equipment, such as hammer mill, knife mill and the like.

Preferably, there is provided a method for the production of a gelatin composition comprising the steps of:
(i) Providing a raw material comprising collagen
(ii) Treating the raw material comprising collagen with alkali, acid, or enzyme to hydrolyse collagen into gelatin
(iii) Extracting gelatin in an aqueous medium at a temperature of from 40° C. to 90° C.
(iv) Adding one or more of a protein hydrolysate, a carbohydrate, an additive, preferably collagen hydrolysate and to provide an aqueous composition comprising gelatin and one or more of a protein hydrolysate, a carbohydrate, an additive
(v) Drying the aqueous composition of step (iv) and
(vi) Optionally grinding or agglomerating, preferably grinding,
   wherein preferably the gelatin composition has a unimodal particle size, more preferably wherein the gelatin composition has
a. From 50 wt % to 80 wt % (by weight of the gelatin composition) of gelatin and
b. From 20 wt % to 50 wt % (by weight of the gelatin composition) of one or more of a protein hydrolysate, a carbohydrate, an additive, preferably collagen hydrolysate.

Preferably the aqueous composition of step (i) has a moisture content of from 20 wt % to 80 wt %, more preferably from 30 wt % to 70 wt %, even more preferably from 40 wt % to 60 wt %.

The one or more of protein hydrolysate, carbohydrate or additive can be added to the gelatine at different stages of the gelatin production process after the gelatin extraction. This can be after the extraction, after the filtration, after the ion exchange step (around 2-10% of gelatin concentration) or concentration increase steps (from 10-55% of gelatin). Preferably, addition will be done after the final evaporation (around 25-55% of gelatin) and prior the sterilisation of the product. Alternatively, gelatin can also be added to collagen hydrolysate during a collagen hydrolysate production process. Gelatin can be added after the hydrolysis step, after the filtration, after the ion exchange step or after the concentration increase step (10-55% of collagen hydrolysate). Typically, collagen hydrolysate is dried by spray drying. The skilled person will know what amount of gelatin can be added to collagen hydrolysate in order to be able to dry by spray drying.

The present invention also relates to a gelatin composition comprising gelatin and one or more of a protein hydrolysate, a carbohydrate, an additive and the like, wherein the composition has a substantially unimodal particle size and is prepared by
(i) Providing an aqueous composition comprising gelatin and one or more of a protein hydrolysate, a carbohydrate, an additive and the like, and
(ii) Drying said aqueous composition; and
(iii) Optionally grinding or agglomerating, preferably grinding.

Preferably the gelatin composition is as defined herein.

The present invention further relates to the use of the composition of the present invention in the production of capsule shells, more preferably soft capsule shells.

The present invention further relates to the use of the composition of the present invention in the production of capsules, more preferably soft capsules.

The present invention further relates to the use of the composition of the present invention as a capsule shell component, preferably as a soft capsule shell component.

It has been found that the use of the composition of the present invention in the production of soft capsule shells and soft capsules is advantageous for the reduction of foam formation during capsule manufacturing process. Also, the use of the composition of the present invention in the production of capsules is advantageous for the reduction of lump formation during capsule manufacturing process.

### Measurement Methods

Following measurement methods are used to determine product parameters outlined in this description.

Moisture content is measured by placing 5 g of the product in an oven at a temperature of 105° C. for 18 hours. The weight difference before and after drying is calculated as the moisture content.

The Bloom value is the mass in grams necessary to depress a standard plunger 4 mm into the gel having a concentration of 6.67% and matured at 10.0° C. for 17 h. A 6.67% solution of the gelatin sample is prepared in a wide-mouthed test bottle at 60° C., cooled to 10° C. and kept for 17 h for maturation at this temperature. The resulting gel is tested using a gelometer according to the GME Monograph Standardised Methods for the Testing of Edible Gelatine (version 12, May 2017).

The viscosity is measured according to British Standard at 6.66%, 60° C. and is expressed in mPa.s. It is measured as described in the GME Monograph Standardised Methods for the Testing of Edible Gelatine (version 12, May 2017).

Transmittance is defined as % T=(I/Iₒ)×100, wherein I is transmitted light and Iₒ is incident light. Transmittance of the composition is measured according to spectrophotometry, where a solution of 6.67 wt % of the composition at 60° C. is measured in a spectrophotometer at 450 nm and 620 nm.

Particle size distribution is measured according to standard method ASTM E11:

Particle size is measured by passing the composition through a series of vibrating sieves put on top of each other, with the sieve at the bottom having the highest mesh size: 8 mesh (2.36 mm), 10 mesh (2 mm), 14 mesh (1.40 mm), 20 mesh (0.85 mm), 40 mesh (0.425 mm), 60 mesh (0.250 mm), 100 mesh (0.150 mm), 200 mesh (0.075 mm), 400 mesh (0.038 mm).

The present invention will be further illustrated by the non-limiting examples.

### EXAMPLES

### Example 1: Production of a Composition According to the Present Invention

A 30 to 35 wt % gelatin solution is provided.
25 to 35 wt % of collagen hydrolysate based on gelatin solid mass is added.
The mixture is homogenized by stirring.
The mixture is passed through a scrape surface heat exchanger at 50 to 70° C. and chilled to a product temperature of 20 to 30° C. The product goes to a drying belt and is dried until it reaches a moisture content of about 11 wt %.
The dried product is ground in a hammer mill.

1. A gelatin composition characterized in that it comprises gelatin and one or more of a protein hydrolysate, a carbohydrate, an additive and the like, characterized in that the composition has a substantially unimodal particle size distribution.

2. The composition of claim 1, preferably comprising gelatin and collagen hydrolysate.

3. The composition of any preceding claim, characterized in that at least 50 wt %, preferably at least 55 wt %, more preferably at least 60 wt %, even more preferably at least 65 wt %, yet even more preferably at least 70 wt %, yet even more preferably at least 75 wt % of the composition has a particle size of more than 1.40 mm up to 2 mm.

4. The composition of any preceding claim, further characterized in that it has a transmittance at 450 nm of at least 50%, preferably 60% or higher, more preferably 65% or higher, and/or a transmittance at 620 nm of at least 60%, preferably 70% or higher, more preferably 75% or higher.

5. The composition of any preceding claim, for use in the production of gelatine capsules.

6. A process to manufacture the composition of claim 1 to 5, comprising the steps of
(i) Providing an aqueous composition comprising gelatin and one or more of a protein hydrolysate, a carbohydrate, an additive; preferably collagen hydrolysate,
(ii) Drying said aqueous composition, and
(iii) Optionally grinding or agglomerating, preferably grinding.

7. The process of claim 6, wherein drying is performed with a drum dryer, tunnel dryer or spray dryer.

8. The process of claim 6, wherein the process comprises the steps of
(i) Providing a raw material comprising collagen,
(ii) Treating the raw material comprising collagen with alkali, acid, or enzyme to hydrolyse collagen into gelatin,
(iii) Extracting gelatin in an aqueous medium at a temperature of from 40°° C. to 90° C.,
(iv) Adding one or more of a protein hydrolysate, a carbohydrate, an additive and/or hydrolysing part of the gelatin to provide an aqueous composition comprising gelatin and one or more of a protein hydrolysate, a carbohydrate, an additive,
(v) Drying the composition obtained in step (iv)
(vi) Optionally grinding or agglomerating, preferably grinding.

9. The process of claims 6 or 7, wherein the aqueous composition of step (i) is obtained by dissolving gelatin and one or more of a protein hydrolysate, a carbohydrate, and an additive in water.

10. Use of the composition of any of claims 1 to 5, in the production of gelatin capsule, preferably soft gelatin capsules.
